(19) United States
(12) Patent Application Publication
(10) Pub. No.: US 2017/0218132 A1
(43) Pub. Date: Aug. 3, 2017

(54) METHOD OF MAKING PLASTIC ARTICLE

(71) Applicant: SABIC GLOBAL TECHNOLOGIES B.V., Bergen op Zoom (NL)

(72) Inventors: Cornelis Johannes G. M van PEER, Noord-Brabant (NL); Dirk Aart NOORDEGRAAF, Roosendaal (NL)

(73) Assignee: SABIC Innovative Plastics IP B.V., Bergen op Zoom (NL)

(21) Appl. No.: 15/500,877

(22) PCT Filed: Jul. 28, 2015
(86) PCT No.: PCT/IB15/55695

§ 371 Date: Jan. 31, 2017

Related U.S. Application Data
(60) Provisional application No. 62/031,730, filed on Jul. 31, 2014.

(51) Int. Cl. C08G 77/448; D06P 3/34; D06P 1/94; C08J 7/02; C08K 5/00

(52) U.S. Cl. CPC C08G 77/448; C08J 7/02; C08K 5/0041; D06P 1/94; D06P 3/34; C08J 2369/00

(57) ABSTRACT

A method of making a plastic article is disclosed. According to this method, a plastic article is formed from a thermoplastic composition that includes a first polymer component that is (i) a poly(siloxane-carbonate) copolymer, (ii) a poly(aliphatic ester)-polycarbonate having soft block ester units, derived from monomers including an alpha, omega C₆₋₂₀ aliphatic dicarboxylic acid or derivative thereof, a dihydroxyaromatic compound, and a carbonate source, (iii) a thermoplastic polyurethane, (iv) a thermoplastic polyurethane, or a combination comprising any of the foregoing. An additive such as a photochromic dye is then loaded into the plastic article by contacting a surface of the article with supercritical fluid carbon dioxide comprising the additive dissolved or dispersed therein.

### BACKGROUND OF THE INVENTION

This disclosure relates to additive-containing plastic articles.

Thermoplastic compositions are useful in the manufacture of articles and components for a wide range of applications, from automotive parts to electronic appliances. Because of their broad use, it is often desirable to include additives in plastic articles in order to impart any of a number of properties or characteristic to the thermoplastic material. Such additives can include colorants such as photochromic dyes, UV absorbers, light stabilizers, heat stabilizers, antistatic agents, antioxidants, flame retardants, and/or antimicrobial agents, among others. Often, these and other additives can be incorporated by mixing into a thermoplastic melt such as during extrusion or molding. However, not all additives have proven to be compatible with incorporation into a thermoplastic melt. For example, some additives are unable to tolerate the melt processing temperatures, which can exceed 270° C. for materials such as polycarbonates. Some additives are not readily dispersed or do not stay dispersed in the thermoplastic melt throughout injection molding processing and solidification, or have other undesired interactions with the thermoplastic melt phase.

Alternative techniques such as imbibition and solvent casting have been used to incorporate additives into thermoplastic materials. These alternative techniques have been proposed for use in situations such as where melt blending is not effective. For example, U.S. Pat. No. 5,286,231 discloses using cyclic ketone solvents such as cyclohexanone, into which an additive is dissolved or dispersed, followed by imbibing the solvent into a solidified polycarbonate material. U.S. Pat. No. 6,114,437 discloses solvent casting a film from a composition comprising polycarbonate, solvent, and additive, followed by evaporation of the solvent. The film can be used, for example, as an insert in injection molding. The use of liquid and/or supercritical carbon dioxide is also known for incorporating dyes into polymer textile fibers.

Dyes are well-known additives for use in various types of plastic articles to provide coloration. Dyes are often melt-blended into the thermoplastic compositions. Melt blending offers advantages such as tight control on dye loading in the thermoplastic composition, low cost, and color going all the way through the article in case of scratches or other surface damage. However, as described above, there are situations where melt blending is not available or does not produce satisfactory performance. For example, polycarbonates are widely favored for use in light-transmitting elements and articles, such as lenses and other optics, windows, skylights, greenhouses, display lights, display panels, as well as eyewear including safety eyewear and goggles, to name but a few. Polycarbonates can offer a number of advantages for such applications, such as favorable refractive index, light weight, impact resistance, etc. Many dyes are effectively melt blended into polycarbonate compositions for such applications, but there are still situations where melt blending is not feasible. For example, in addition to the above-mentioned situations of incompatibility with the thermoplastic melt and/or melt temperature, if a dye is used for color effect in a light-transmitting element or article that has varying thickness, melt blending can produce undesirable light absorbance variations, with thicker areas appearing darker than thinner areas. Surface coatings can be used as an alternative to provide light absorbance, but they are susceptible to being scratched or marred, and even delamination. Imbibition is another alternative technique that has been used, for example, in eyewear and other optics applications. Imbibition can provide uniform coloration if concentration and penetration depth can be controlled, and is known to be used for eyewear and other optics applications such as those described above. However, imbibition has not been widely effective with some thermoplastics such as polycarbonates, often leaving melt blending as the only alternative.

A class of dyes that has found increasing use in eyewear as well as other optics and light-transmitting element applications is the class of photochromic dyes. These dyes are capable of displaying remarkable reversible color variation, and can be used to provide light transmitting plastic elements and articles with coloration that varies upon exposure to UV light such as is commonly encountered in outdoor sunlight. For eyewear and similar applications, photochromic dyes are often added by imbibition into the surface of some types of plastic lenses, but photochromic dye imbibition has not been effective with polycarbonates. Photochromic polycarbonate eyewear lenses are typically made by bonding a scratch-resistant photochromic composite layer onto a polycarbonate lens surface, which adds complexity and expense to the lens fabrication process.

The various techniques such as melt blending, imbibition, and solvent casting all work with varying degrees of effectiveness for incorporating additives into thermoplastics. However, alternatives that may be more appropriate for certain applications, provide better performance, lower cost, or any combination of these are still desired.

### SUMMARY OF THE INVENTION

The above-described issues are addressed by a method of making a plastic article as described in further detail below. According to this method, a plastic article is formed comprising a first polymer component that is (i) a poly(siloxane-carbonate) copolymer, (ii) a poly(aliphatic ester)-polycarbonate comprising soft block ester units, derived from monomers comprising an alpha, omega C₆₋₂₀ aliphatic dicarboxylic acid or derivative thereof, a dihydroxyaromatic compound, and a carbonate source, (iii) a blend of a polycarbonate and a polyester, (iv) a thermoplastic polyurethane, or a combination comprising any of the foregoing. An additive such as a photochromic dye is then loaded into the plastic article by contacting a surface of the article with supercritical fluid carbon dioxide comprising the additive dissolved or dispersed therein.

The above described and other features are further described by the description below.

### DETAILED DESCRIPTION OF THE INVENTION

Without being bound by theory, it is believed that the favorable results obtained herein, i.e., thermoplastic compositions having beneficial levels and/or depth of penetration of additive imbibition through supercritical CO₂ processing, are unexpectedly obtained with (i) poly(siloxane-carbonate) copolymers, (ii) poly(aliphatic ester)-polycarbonates comprising soft block ester units, derived from monomers comprising an alpha, omega C₆₋₂₀ aliphatic dicarboxylic acid or derivative thereof, a dihydroxyaromatic compound, and a carbonate source, (iii) a blend of a polycarbonate and a polyester, or (iv) thermoplastic polyurethanes.

The poly(siloxane-carbonate) copolymers on which the thermoplastic composition can be based, also referred to in the art as polysiloxane-polycarbonates or polyorganosiloxane-carbonates, comprise a combination of repeating structural carbonate units and repeating diorganosiloxane carbonate units. The carbonate units are of formula (1)

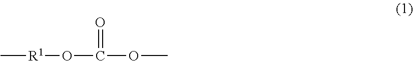

in which at least 60 percent of the total number of R¹ groups contain aromatic moieties and the balance thereof are aliphatic, alicyclic, or aromatic. In some embodiments, each R¹ is a C₆₋₃₀ aromatic group, that is, contains at least one aromatic moiety. R¹ can be derived from a dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In some embodiments, one atom separates A¹ from A². Specifically, each R¹ can be derived from a dihydroxy aromatic compound of formula (3)

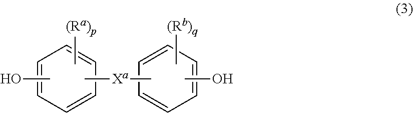

wherein R^{a} and R^{b} are each independently a halogen or C₁₋₁₂ alkyl group; and p and q are each independently integers of 0 to 4. It will be understood that R^{a} is hydrogen when p is 0, and likewise R^{b} is hydrogen when q is 0. Also in formula (3), X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In an embodiment, p and q is each 1, and R^{a} and R^{b} are each a C₁₋₃ alkyl group, specifically methyl, disposed meta to the hydroxy group on each arylene group.

In some embodiments, X^{a} is a substituted or unsubstituted C₃₋₁₈ cycloalkylidene, a C₁₋₂₅ alkylidene of formula —C(R^{c})(R^{d})— wherein R^{e} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. A specific example wherein X^{a} is a substituted cycloalkylidene is the cyclohexylidene-bridged, alkyl-substituted bisphenol of formula (4)

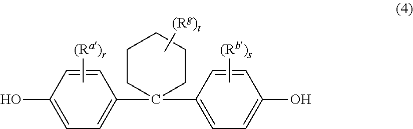

wherein R^{a′} and R^{b′} are each independently C₁₋₁₂ alkyl, R^{g} is C₁₋₁₂ alkyl or halogen, r and s are each independently 1 to 4, and t is 0 to 10. More specifically, at least one of each of R^{a′} and R^{b′} can be disposed meta to the cyclohexylidene bridging group. The substituents R^{a′}, R^{b′}, and R^{g} can, when comprising an appropriate number of carbon atoms, be straight chain, cyclic, bicyclic, branched, saturated, or unsaturated. In some embodiments, R^{a′} and R^{b′} are each independently C₁₋₄ alkyl, R^{g} is C₁₋₄ alkyl, r and s are each 1, and t is 0 to 5. In some more specific embodiments, R^{a′}, R^{b′} and R^{g} are each methyl, r and s are each 1, and t is 0 or 3. The cyclohexylidene-bridged bisphenol can be the reaction product of two moles of o-cresol with one mole of cyclohexanone. In some embodiments, the cyclohexylidene-bridged bisphenol is the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures.

In some embodiments, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

X^{a} can also be a substituted C₃₋₁₈ cycloalkylidene of formula (5)

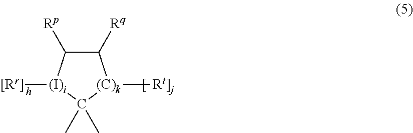

wherein R^{r}, R^{p}, R^{q}, and R^{t} are each independently hydrogen, halogen, oxygen, or C₁₋₁₂ organic groups; I is a direct bond, a carbon, or a divalent oxygen, sulfur, or —N(Z)— where Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (5) will have an unsaturated carbon-carbon linkage where the ring is fused. When k is one and i is 0, the ring as shown in formula (5) contains 4 carbon atoms, when k is 2, the ring as shown in formula (5) contains 5 carbon atoms, and when k is 3, the ring contains 6 carbon atoms. In an embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

Other useful aromatic dihydroxy compounds of the formula HO—R¹—OH include compounds of formula (6)

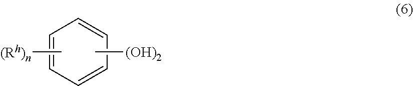

wherein each Rⁿ is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

The poly(siloxane-carbonate) copolymer further contains diorganosiloxane (“siloxane”) units, generally in the form of blocks. The polydiorganosiloxane (“polysiloxane”) blocks of the copolymer comprise repeating siloxane units as in formula (10)

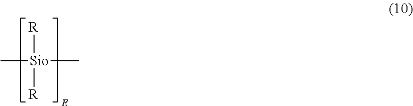

wherein each R is independently a C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

The value of E in formula (10) can vary widely depending on the type and relative amount of each component in the thermoplastic composition, the desired properties of the composition, and like considerations. Generally, E has an average value of 2 to about 1,000, specifically about 2 to about 500, more specifically about 5 to about 100. In an embodiment, E has an average value of about 10 to about 75, and in still another embodiment, E has an average value of about 40 to about 60. Where E is of a lower value, e.g., less than about 40, it can be desirable to use a relatively larger amount of the polycarbonate-polysiloxane copolymer. Conversely, where E is of a higher value, e.g., greater than about 40, a relatively lower amount of the polycarbonate-polysiloxane copolymer can be used.

A combination of a first and a second (or more) polycarbonate-polysiloxane copolymers can be used, wherein the average value of E of the first copolymer is less than the average value of E of the second copolymer.

In some embodiments embodiment, the polysiloxane blocks are of formula (11)

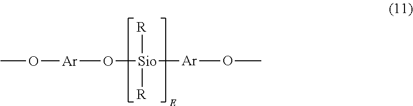

wherein E is as defined above; each R can be the same or different, and is as defined above; and Ar can be the same or different, and is a substituted or unsubstituted C₆-C₃₀ arylene group, wherein the bonds are directly connected to an aromatic moiety. Ar groups in formula (11) can be derived from a C₆-C₃₀ dihydroxyarylene compound, for example a dihydroxyarylene compound of formula (3) or (6) above. Exemplary dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane. Combinations comprising at least one of the foregoing dihydroxy compounds can also be used.

In some embodiments, the polysiloxane blocks are of formula (13)

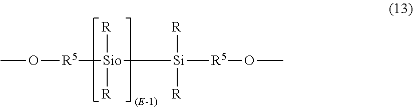

wherein R and E are as described above, and each R⁵ is independently a divalent C₁-C₃₀ organic group, and wherein the polymerized polysiloxane unit is the reaction residue of its corresponding dihydroxy compound. In some, more specific, embodiments, the polysiloxane blocks are of formula (14):

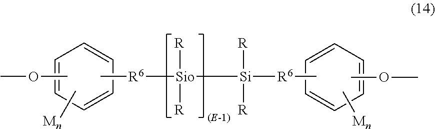

wherein R and E are as defined above. R⁶ in formula (14) is a divalent C₂-C₈ aliphatic group. Each M in formula (14) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

In some embodiments, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In some embodiments, R is methyl, or a combination of methyl and trifluoropropyl, or a combination of methyl and phenyl. In some, more specific. embodiments, M is methoxy, n is one, R² is a divalent C₁-C₃ aliphatic group, and R is methyl.

Blocks of formula (14) can be derived from the corresponding dihydroxy siloxane (15)

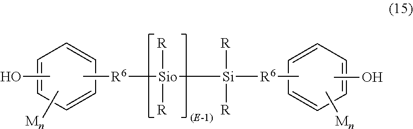

wherein R, E, M, R⁶, and n are as described above. Such dihydroxy polysiloxanes can be made by effecting a platinum-catalyzed addition between a siloxane hydride of formula (16)

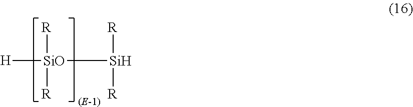

wherein R and E are as previously defined, and an aliphatically unsaturated monohydric phenol. Exemplary aliphatically unsaturated monohydric phenols include eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Combinations comprising at least one of the foregoing can also be used.

Poly(siloxane-carbonate) copolymers can comprise 50 to 99 weight percent of carbonate units and 1 to 50 weight percent siloxane units. Within this range, the poly(siloxane-carbonate)copolymer can comprise 70 to 98 weight percent, more specifically 75 to 97 weight percent of carbonate units and 2 to 30 weight percent, more specifically 3 to 25 weight percent siloxane units. Poly(siloxane-carbonate) copolymers can be manufactured by processes used for polycarbonates where a dihydroxy siloxane, such as a compound according to formula (15) above, is included as one of the dihydroxy compounds used in the polycarbonate polymerization process.

Poly(siloxane-carbonate) copolymers can have a weight average molecular weight of 2,000 to 100,000 Daltons, specifically 5,000 to 50,000 Daltons as measured by gel permeation chromatography using a crosslinked styrene-divinyl benzene column, at a sample concentration of 1 milligram per milliliter, and as calibrated with polycarbonate standards.

Poly(siloxane-carbonate) copolymers can have a melt volume flow rate, measured at 300° C./1.2 kg, of 1 to 50 cubic centimeters per 10 minutes (cc/10 min), specifically 2 to 30 cc/10 min. Mixtures of poly(siloxane-carbonate)s of different flow properties can be used to achieve the overall desired flow property.

The thermoplastic composition can also be based on a poly(aliphatic ester)-polycarbonates comprising soft block ester units, derived from monomers comprising an alpha, omega C₆₋₂₀ aliphatic dicarboxylic acid or derivative thereof, a dihydroxyaromatic compound, and a carbonate source. In some embodiments, the poly(aliphatic ester)-polycarbonate has ester units of formula (6) comprising soft block ester units, also referred to herein as aliphatic dicarboxylic acid ester units. Such a polyester-polycarbonate copolymer comprising soft block ester units is also referred to herein as a poly(aliphatic ester)-polycarbonate. The soft block ester unit can be a C₆₋₂₀ aliphatic dicarboxylic acid ester unit (where C₆₋₂₀ includes the terminal carboxyl groups), and can be straight chain (i.e., unbranched) or branched chain dicarboxylic acids, cycloalkyl or cycloalkylidene-containing dicarboxylic acids units, or combinations of these structural units. In some embodiments, the C₆₋₂₀ aliphatic dicarboxylic acid ester unit includes a straight chain alkylene group comprising methylene (—CH₂—) repeating units. In some embodiments, a soft block ester unit comprises units of formula (6a)

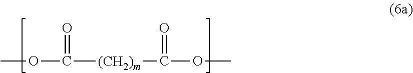

wherein m is 4 to 18, more specifically 8 to 10. The poly(aliphatic ester)-polycarbonate can include less than or equal to 25 weight % of the soft block unit. The poly(aliphatic ester)-polycarbonate can comprise units of formula (6a) in an amount of 0.5 to 10 weight %, specifically 2 to 9 weight %, and more specifically 3 to 8 weight %, based on the total weight of the poly(aliphatic ester)-polycarbonate. The poly(aliphatic ester)-polycarbonate can have a glass transition temperature of 110 to 145° C., specifically 115 to 145° C., more specifically 128 to 139° C., even more specifically 130 to 139° C.

The poly(aliphatic ester)-polycarbonate is a copolymer of soft block ester units with carbonate units. Exemplary poly(aliphatic ester)-polycarbonates can be represented by formula (6b)

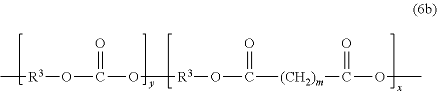

where each R³ is independently derived from a dihydroxyaromatic compound of formula (3) or (5), m is 4 to 18, and x and y each represent average weight percentages of the poly(aliphatic ester)-polycarbonate where the average weight percentage ratio x:y is 10:90 to 0.5:99.5, specifically 9:91 to 1:99, and more specifically 8:92 to 3:97, where x+y is 100.

Soft block ester units, as defined herein, can be derived from an alpha, omega C₆₋₂₀, specifically, C₁₀₋₁₂, aliphatic dicarboxylic acid or a reactive derivative thereof. The carboxylate portion of the aliphatic ester unit of formula (6a), in which the terminal carboxylate groups are connected by a chain of repeating methylene (—CH₂—) units (where m is as defined for formula (6a)), can be derived from the corresponding dicarboxylic acid or reactive derivative thereof, such as the acid halide (specifically, the acid chloride), an ester, or the like. Exemplary alpha, omega dicarboxylic acids (from which the corresponding acid chlorides can be derived) include alpha, omega C₆ dicarboxylic acids such as hexanedioic acid (also referred to as adipic acid); alpha, omega C₁₀ dicarboxylic acids such as decanedioic acid (also referred to as sebacic acid); and alpha, omega C₁₂ dicarboxylic acids such as dodecanedioic acid (sometimes abbreviated as DDDA). It will be appreciated that the aliphatic dicarboxylic acid is not limited to these exemplary carbon chain lengths, and that other chain lengths within the C₆₋₂₀ limitation can be used. In some embodiments, the poly(aliphatic ester)-polycarbonate having soft block ester units comprising a straight chain methylene group and a bisphenol A polycarbonate group is shown in formula (6c)

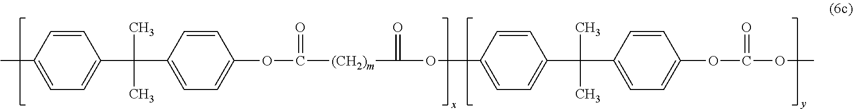

where m is 4 to 18 and x and y are as defined for formula (6b). In an embodiment, the poly(aliphatic ester)-polycarbonate copolymer comprises sebacic acid ester units and bisphenol A carbonate units (formula (6c), where m is 8, and the average weight ratio of x:y is 6:94).

The poly(aliphatic ester)-polycarbonate copolymer, as described above, can be a polycarbonate having aliphatic dicarboxylic acid ester soft block units randomly incorporated along the copolymer chain. The introduction of the soft block segment (e.g., a flexible chain of repeating CH₂ units) in the polymer chain of a polycarbonate reduces the glass transition temperatures (T_{g}) of the resulting soft block containing polycarbonate copolymer. These materials are generally transparent and have higher melt volume ratios than polycarbonate homopolymers or copolymers without the soft block.

The poly(aliphatic ester)-polycarbonate copolymer, i.e., a polycarbonate having aliphatic dicarboxylic acid ester soft block units randomly incorporated along the copolymer chain, has soft block segment (e.g., a flexible chain of repeating —CH₂— units) in the polymer chain, where inclusion of these soft block segments in a polycarbonate reduces the glass transition temperatures (T_{g}) of the resulting soft block-containing polycarbonate copolymer. Exemplary thermoplastic compositions comprise soft block in amounts of 0.5 to 10 wt %, and from 0.5% to 6% in more specific exemplary embodiments, based on the weight of the poly(aliphatic ester)-polycarbonate, are transparent and have higher MVR than polycarbonate homopolymers or copolymers without the soft block.

Exemplary thermoplastic compositions include poly(sebacic acid ester)-co-(bisphenol A carbonate). It will be understood that a wide variety of thermoplastic compositions and articles derived from them can be obtained by not only changing the thermoplastic compositions (e.g., by replacing sebacic acid with adipic acid in the poly(sebacic acid ester)-co-(bisphenol A carbonate) but by changing the amounts of sebacic or other aliphatic acid content in the blends while maintaining a constant molecular weight or while varying the molecular weight. Similarly, new thermoplastic compositions can be identified by changing the molecular weights of the components in the exemplary copolymer blends while keeping, for example, sebacic acid content constant.

Properties such as ductility, transparency and melt flow of the thermoplastic compositions may be varied by the composition of the poly(aliphatic ester)-polycarbonate. For example, wt % of aliphatic dicarboxylic acid ester units (e.g., sebacic acid) may be varied from 1 to 10 wt % of the total weight of the thermoplastic composition. The distribution (in the polymer chain) of the sebacic acid (or other dicarboxylic acid ester) in the copolymers may also be varied by choice of synthetic method of the poly(aliphatic ester)-polycarbonate copolymers (e.g., interfacial, melt processed, or further reactive extrusion of a low MVR poly(aliphatic ester)-polycarbonate with a redistribution catalyst) to obtain the desired properties.

Polyester-polycarbonate copolymers generally can have a weight average molecular weight (M_{w}) of 1,500 to 100,000 grams per mole (g/mol), specifically 1,700 to 50,000 g/mol. In an embodiment, poly(aliphatic ester)-polycarbonates have a molecular weight of 15,000 to 45,000 g/mol, specifically 17,000 to 40,000 g/mol, more specifically 20,000 to 30,000 g/mol, and still more specifically 20,000 to 25,000 g/mol. Molecular weight determinations are performed using gel permeation chromatography (GPC), using a cross-linked styrene-divinylbenzene column and calibrated to polycarbonate references, with samples prepared at a concentration of 1 milligram (mg)/mL, and are eluted at a flow rate of 1.0 mL/min.

The first polymer component can also be a blend of a polycarbonate and a polyester, both of which should be amorphous. For example, a blended polymer can include a BPA polycarbonate and poly(1,4-cyclohexane dimethylene 1,4-cyclohexanedicarboxylate) (PCCD). The relative amounts of the polycarbonate and polyester can vary, with the polyester comprising from 1 wt. % up to 60 wt. % polyester based on the weight of the first polymer component.

Exemplary polyesters include those derived from an aliphatic, cycloaliphatic, or aromatic diol, or mixtures thereof, containing from 2 to about 10 carbon atoms and an aliphatic, cycloaliphatic, or aromatic dicarboxylic acid, and have repeating units of the following general formula:

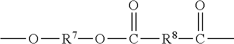

wherein n is an integer of from 2 to 6, and R⁷ and R⁸ are each independently a divalent C₁-C₂₀ aliphatic radical, a C₂-C₁₂ cycloaliphatic alkyl radical, or a C₆-C₂₄ aromatic radical.

The diol may be a glycol, such as ethylene glycol, propylene glycol, trimethylene glycol, 2-methyl-1,3-propane glycol, hexamethylene glycol, decamethylene glycol, cyclohexane dimethanol, or neopentylene glycol; or a diol such as 1,4-butanediol, hydroquinone, or resorcinol.

Examples of aromatic dicarboxylic acids represented by the decarboxylated residue R are isophthalic or terephthalic acid, 1,2-di(p-carboxyphenyl)ethane, 4,4′-dicarboxydiphenyl ether, 4,4′ bisbenzoic acid, and mixtures thereof. All of these acids contain at least one aromatic nucleus. Acids containing fused rings can also be present, such as in 1,4-1,5- or 2,6-naphthalene dicarboxylic acids. The preferred dicarboxylic acids are terephthalic acid, isophthalic acid, naphthalene dicarboxylic acid or a mixture thereof.

Also contemplated herein are the above polyesters with minor amounts, e.g., from about 0.5 to about 30 percent by weight, of units derived from aliphatic acids and/or aliphatic polyols to form copolyesters. The aliphatic polyols include glycols, such as poly(ethylene glycol). Such polyesters can be made following the teachings of, for example, U.S. Pat. Nos. 2,465,319 and 3,047,539.

In some embodiments, the polyesters are poly(ethylene terephthalate) (“PET”), poly(1,4-butylene terephthalate), (“PBT”), and poly(propylene terephthalate) (“PPT”). An exemplary PBT resin is one obtained by polymerizing a glycol component at least 70 mole %, preferably at least 80 mole %, of which consists of tetramethylene glycol and an acid component at least 70 mole %, preferably at least 80 mole %, of which consists of terephthalic acid, and polyester-forming derivatives therefore. In some embodiments, the glycol component contains not more than 30 mole %, preferably not more than 20 mole %, of another glycol, such as ethylene glycol, trimethylene glycol, 2-methyl-1,3-propane glycol, hexamethylene glycol, decamethylene glycol, cyclohexane dimethanol, or neopentylene glycol. In some embodiments, the acid component contains not more than 30 mole %, preferably not more than 20 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethane dicarboxylic acid, p-hydroxy benzoic acid, sebacic acid, adipic acid and polyester-forming derivatives thereof.

Block copolyester resin components can also be used, and can be prepared by the transesterification of (a) straight or branched chain poly(1,4-butylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. For example a poly(1,4-butylene terephthalate) can be mixed with a polyester of adipic acid with ethylene glycol, and the mixture heated at 235° C. to melt the ingredients, then heated further under a vacuum until the formation of the block copolyester is complete. As the second component, there can be substituted poly(neopentyl adipate), poly(1,6-hexylene azelate-coisophthalate), poly(1,6-hexylene adipate-co-isophthalate) and the like. An exemplary block copolyester of this type is available commercially from General Electric Company, Pittsfield, Mass., under the trade designation VALOX 330.

Branched high melt viscosity poly(1,4-butylene terephthalate) resins can be used when high melt strength is important. Such resins can include an amount greater than zero up to 5 mole percent based on the terephthalate units, of a branching component containing at least three ester forming groups. The branching component can be one that provides branching in the acid unit portion of the polyester, or in the glycol unit portion, or it can be hybrid. Illustrative of such branching components are tri- or tetracarboxylic acids, such as trimesic acid, pyromellitic acid, and lower alkyl esters thereof, and the like, or preferably, polyols, and especially preferably, tetrols, such as pentaerythritol, triols, such as trimethylolpropane; or dihydroxy carboxylic acids and hydroxydicarboxylic acids and derivatives, such as dimethyl hydroxyterephthalate, and the like. The branched poly(1,4-butylene terephthalate) resins and their preparation are described in Borman, U.S. Pat. No. 3,953,404, incorporated herein by reference. In addition to terephthalic acid units, small amounts, e.g., from 0.5 to 15 percent by weight of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like. In addition, the poly(1,4-butylene terephthalate) resin component can also include other high molecular weight resins, in minor amount, such as poly(ethylene terephthalate), block copolyesters of poly(1,4-butylene terephthalate) and aliphatic/aromatic polyesters, and the like. The molecular weight of the poly(1,4-butylene terephthalate) should be sufficiently high to provide an intrinsic viscosity of about 0.6 to 2.0 deciliters per gram, preferably 0.8 to 1.6 dl.g/., measured, for example, as a solution in a 60:40 mixture of phenol and tetrachloroethane at 30° C.

Polycarbonate-containing polymers such as the poly(siloxane-carbonate) copolymers and the poly(aliphatic ester)-polycarbonate copolymers described herein can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate source (i.e., carbonate precursor) in the presence of a catalyst such as, for example, a tertiary amine or a phase transfer catalyst, under controlled pH conditions, e.g., about 8 to about 10. The most commonly used water immiscible solvents include methylene chloride, 1,2-dichloroethane, chlorobenzene, toluene, and the like.

Exemplary carbonate precursors include a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary embodiment, an interfacial polymerization reaction to form carbonate linkages uses phosgene as a carbonate precursor, and is referred to as a phosgenation reaction.

Among tertiary amines that can be used are aliphatic tertiary amines such as triethylamine, tributylamine, cycloaliphatic amines such as N,N-diethyl-cyclohexylamine and aromatic tertiary amines such as N,N-dimethylaniline.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt % based on the weight of bisphenol in the phosgenation mixture. In another embodiment an effective amount of phase transfer catalyst can be about 0.5 to about 2 wt % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates. Mono-phenolic chain stoppers are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Alternatively, melt processes can be used to make the polycarbonates. Generally, in the melt polymerization process, polycarbonates are prepared by co-reacting, in a molten state, the dihydroxy reactant(s) (i.e. aliphatic diol and/or aliphatic diacid, and any additional dihydroxy compound) and a diaryl carbonate ester, such as diphenyl carbonate, or an activated carbonate such as bis(methyl salicyl) carbonate, in the presence of a transesterification catalyst. The reaction may be carried out in typical polymerization equipment, such as one or more continuously stirred reactors (CSTR's), plug flow reactors, wire wetting fall polymerizers, free fall polymerizers, wiped film polymerizers, BANBURY™ mixers, single or twin screw extruders, or combinations of the foregoing. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl) carbonate, bis(2-acetylphenyl) carboxylate, bis(4-acetylphenyl) carboxylate, or a combination comprising at least one of the foregoing.

Transesterification catalysts include but are not limited to one or more inorganic or organic salts of alkali metals or alkali earth metals or other metals as well as nitrogen or phosphorus containing organic or inorganic basic salts. Some examples of transesterification catalysts include but are not limited to sodium, lithium, potassium magnesium, calcium zinc, tin, antimony, boron or aluminum containing salts of acetates, alcoholates, borates, carbonates, oxides, EDTA, hydroxides, hydrides, oxides, oxo salts of sulfur, phosphites, and phosphates, aromatic sulfonates and aromatic tosylates. Some examples of phosphorus or nitrogen containing basic salts include but are not limited to alkyl or aryl or alkyl-aryl ammonium or phosphonium, acetates, benzoates, borohydrides, borates, formates or hydroxides. Quenching of the transesterification catalysts and any reactive catalysts residues with an acidic compound after polymerization is completed can also be useful in some melt polymerization processes. Removal of catalyst residues and/or quenching agent and other volatile residues from the melt polymerization reaction after polymerization is completed can also be useful in some melt polymerization processes.

The thermoplastic composition can also be based on a thermoplastic polyurethane (“TPU”). TPU is formed by the reaction one or more polyols with one or more polyisocyanates. Exemplary polyols include polyester polyols or polyether polyols. Polyester polyols can be produced from a reaction of a dicarboxylic acid and a glycol having at least one primary hydroxyl group. Dicarboxylic acids include adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Glycols for use in producing the polyester polyols include ethylene glycol, butylene glycol, hexanediol, bis(hydroxymethylcyclohexane), 1,4-butanediol, diethylene glycol, 2,2-dimethyl propylene glycol, 1,3-propylene glycol, and combinations thereof. Polyether polyols include polytetramethylene glycol, polyethylene glycol, polypropylene glycol, and combinations thereof.

The isocyanate component that is used to form the TPU can include diisocyanates, polyisocyanates, biurets of isocyanates and polyisocyanates, isocyanurates of isocyanates and polyisocyanates, and combinations thereof. In some embodiments, the isocyanate component includes an n-functional isocyanate. In this embodiment, n can be a number from 2 to 5, preferably from 2 to 4, and most preferably from 2 to 3. In some embodiments, the isocyanate component is chosen from aromatic isocyanates, aliphatic isocyanates, or combinations thereof. In some embodiments, the isocyanate component includes an aliphatic isocyanate such as hexamethylene diisocyanate, H12MDI, and combinations thereof. If the isocyanate component includes an aliphatic isocyanate, the isocyanate component may also include a modified multivalent aliphatic isocyanate, i.e., a product which is obtained through chemical reactions of aliphatic diisocyanates and/or aliphatic polyisocyanates. Examples include ureas, biurets, allophanates, carbodiimides, uretonimines, isocyanurates, urethane groups, dimers, trimers, and combinations thereof. The isocyanate component may also include modified diisocyanates employed individually or in reaction products with polyoxyalkyleneglycols, diethylene glycols, dipropylene glycols, polyoxyethylene glycols, polyoxypropylene glycols, polyoxypropylene polyoxyethylene glycols, polyesterols, polycaprolactones, and combinations thereof

Alternatively, the isocyanate component may include an aromatic isocyanate. If the isocyanate component includes an aromatic isocyanate, the aromatic isocyanate may correspond to the formula R′(NCO).sub.z wherein R′ is aromatic and z is an integer that corresponds to the valence of R′. Preferably, z is at least two. Suitable examples of aromatic isocyanates include, but are not limited to, tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene diisocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof. In one embodiment, the isocyanate component includes a diisocyanate selected from the group of methylene diphenyl diisocyanates, toluene diisocyanates, hexamethylene diisocyanates, H12MDIs, and combinations thereof.

In some embodiments, the TPU further includes the reaction product of a chain extender, in addition to the polyester polyols or polyether polyols. In some embodiments, the TPU can include the reaction product of the chain extender and the isocyanate in place of polyester polyols and/or polyether polyols. Chain diols include ethylene glycol, propylene glycol, butylene glycol, 1,4-butanediol, butenediol, butynediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), hexanediol, and thiodiglycol; diamines including ethylene diamine, propylene diamine, butylene diamine, hexamethylene diamine, cyclohexylene diamine, phenylene diamine, tolylene diamine, xylylene diamine, 3,3′-dichlorobenzidine, and 3,3′-dinitrobenzidine; alkanol amines including ethanol amine, aminopropyl alcohol, 2,2-dimethyl propanol amine, 3-aminocyclohexyl alcohol, and p-aminobenzyl alcohol; and combinations of any of the aforementioned chain extenders.

In some embodiments, the isocyanate component has a maximum limit on NCO content, for example 85.7 wt. % based on the total weight of the isocyanate component. The isocyanate component can also react with the polyol and/or chain extender in any amount, as determined by one skilled in the art. Preferably, the isocyanate component and the polyol and/or chain extender are reacted at an isocyanate index of from 90 to 115, more preferably from 95 to 105, and alternatively from 105 to 110. Examples of suitable polyester-based TPUs that may be used in this invention include, but are not limited to ELASTOLLAN™ C78A available from BASF.

The thermoplastic composition can also include blends of two or more of: (i) a poly(siloxane-carbonate) copolymer, (ii) a poly(aliphatic ester)-polycarbonate comprising soft block ester units, derived from monomers comprising an alpha, omega C₆₋₂₀ aliphatic dicarboxylic acid or derivative thereof, a dihydroxyaromatic compound, and a carbonate source, (iii) polycarbonate/polyester mixtures, and (iv) a thermoplastic polyurethane. The thermoplastic composition can optionally include, blended with the first polymer component, other polymers such as polyesters, polyether ketones, polystyrenes, or polycarbonates other than a poly(siloxane-carbonate) copolymer or a poly(aliphatic ester)-polycarbonate comprising soft block ester units, as well as other polymers. For example, in some embodiments, the first polymer component is a poly(siloxane-carbonate) copolymer is blended with a second polymer component, which can be a polycarbonate that is, in some embodiments, free of siloxane units. By “free”, it is meant that no measurable amount of siloxane can be detected in accordance with currently available measurement techniques. As used herein, the term “polycarbonate” means compositions having repeating structural carbonate units of formula (1) as described above, which can be derived from a dihydroxy compound as described above. “Polycarbonates” as used herein further include homopolycarbonates (wherein each R¹ in the polymer is the same), copolymers comprising different R¹ moieties in the carbonate (referred to herein as “copolycarbonates”), copolymers comprising carbonate units and other types of polymer units, such as ester units, and combinations comprising at least one of homopolycarbonates and/or copolycarbonates. As used herein, a “combination” is inclusive of blends, mixtures, alloys, reaction products, and the like. In some embodiments, the non-siloxane polycarbonate is BPA polycarbonate (i.e., a polycarbonate using bisphenol A (BPA) as its only dihydroxy compound).

The thermoplastic composition can further include impact modifier(s). Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a Tg less than about 10° C., more specifically less than about −10° C., or more specifically about −40° to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than about 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers. materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

When present, impact modifiers can be present in amounts of 1 to 30 wt. %, based on the total weight of the polymers in the composition.

In addition to the first polymer component and other component(s) described above, the thermoplastic composition can include various additives ordinarily incorporated into polymer compositions of this type to achieve desired properties and avoid undesired properties. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. Combinations of additives can also be used, as is known in the art, for example a heat stabilizer, mold release agent, and ultraviolet light stabilizer. In general, the additives can be used in the amounts generally known to be effective. The total amount of additives (other than any impact modifier, filler, or reinforcing agents) is generally 0.01 to 5 wt. %, based on the total weight of the composition.

Additives can be incorporated by any technique appropriate for the particular additive(s), such as melt blending during extrusion, compounding, or injection molding, solvent imbibing, or by mixing the additive with a solvent and the thermoplastic followed by solvent casting, subject to the proviso that at least one additive is incorporated by supercritical CO₂ imbibition. In some embodiments, the additive incorporated by CO₂ imbibition is a colorant, such as an organic dye or pigment. In some embodiments, the additive incorporated by CO₂ imbibition is an inorganic colorant such as a silver halide. In some embodiments, the additive incorporated by supercritical CO₂ imbibition is a photochromic dye.

Photochromic compounds are well-known, as are methods for their preparation. Examples of naphthopyran compounds suitable for imparting photochromic properties can be represented by formula (17)

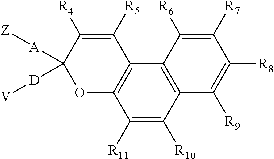

wherein R₄, R₅, R₆, R₇, R₈, R₉, R₁₀, and R₁₁, respectively, may be hydrogen; a stable organic radical, such as alkyl, alkoxy, unsubstituted or substituted phenyl, naphthyl, cycloalkyl, furyl, alkoyl, alkoyloxy, aroyl, aroyloxy; a heterocyclic group: halogen; a nitrogen-substituted group, such as amino or nitro; or a nitrogen-substituted ring compound, such as morpholino, piperidino, or piperazino; Z is hydrogen, a substituted phenyl group or a substituted naphthyl group; and V is hydrogen, a substituted phenyl group or a substituted naphthyl group, provided that at least one of Z and V is substituted phenyl or substituted naphthyl. The substituents of any phenyl or naphthyl group or groups at Z or V are selected from the following: a stable organic radical, such as alkyl, alkoxy, unsubstituted or substituted phenyl, naphthyl, cycloalkyl, furyl, alkoyl, alkoyloxy, aroyl, aroyloxy; a heterocyclic group; halogen; a nitrogen-substituted group, such as amino or nitro; and a nitrogen-substituted ring compound, such as morpholino, piperidino, or piperazino; provided that at least one substituent of at least one substituted phenyl or substituted naphthyl at either A or B is phenyl, naphthyl or furyl.

Examples of naphthopyran compounds include 3-(4-biphenylyl)-3-phenyl-8-methoxy-3H-naphtho [2,1b]pyran, 3-(4-biphenylyl)-3-phenyl-3H-naphtho-[2,1b] pyran and 3,3-di(4-biphenylyl)-8-methoxy-3H-naphtho-[2,1b]pyran.

Spironaphthopyran photochromic compounds can be represented by formula (18):

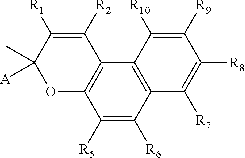

wherein R₁, R₂, R₅ R₆, R₇, R₈, R₉, and R₁₀, respectively, may be hydrogen; a stable organic radical, such as alkyl, alkoxy, phenyl, naphthyl, cycloalkyl, furyl, alkoyl, alkoyloxy, aroyl, aroyloxy; a heterocyclic group; a halogen; a nitrogen-substituted group, such as amino or nitro; or a nitrogen-substituted ring compound, such as morpholino, piperidino, or piperazino; A is a substituted divalent aromatic radical. The substituents of the divalent aromatic radical may be hydrogen or a stable organic radical such as alkyl, alkoxy, phenyl, naphthyl, cycloalkyl, fury], alkoyl, alkoyloxy, aroyl, or aroyloxy. Additionally, the substituents of the substituted divalent may also be substituted with alkyl, alkoxy, phenyl, naphthyl, cycloalkyl, furyl, alkoyl, alkoyloxy, aroyl, or aroyloxy

Examples of spironaphthopyran compounds for imparting photochromic effects include 8-methoxyspiro(3H-naphtho[2,1-b]pyran-3,9′-fluorene), spiro(3H-naphtho [2,1-b]pyran-3,9′-fluorene), 8-methoxyspiro(3H-naphtho[2,1-b]pyran-3,1′-tetralone), 6′,7′-dimethoxy-8-methoxyspiro(3H-naphtho [2,1-b]pyran-3,1′-tetralone) 7′-methoxy-8-methoxyspiro(3H-naphtho[2,1-b]pyran 3,1′-tetralone), 2′,3′-diphenyl-8-methoxyspiro(3H-naphtho[2,1-b]pyran-3,1′-tetralone) 2′-methyl-8-methoxyspiro(3H-naphtho [2,1-b]pyran-3,1′-tetralone), 2′-methyl-8-methoxy spiro(3H-naphtho(2,I-b]pyran-3,1′-indan), 2′,3′ diphenyl-8-methoxyspiro (3H-naphtho [2,1-b]pyran-3,1′-indene), 2′,3′-diphenyl-8-methoxyspiro(3H-naphtho[2,1-b]pyran-3,1-tetralone), 2′-methyl-8-methoxyspiro(3H-naphtho[2,1-b]pyran-3,1-tetralone), 2′methyl-8-methoxyspiro(3H-naphtho[2,1-b]pyran-indan), and 2′,3′-diphenyl-8-methoxyspiro(3H-naphtho[2,1-b]pyran-3,1′-indene.

Further details and methods for manufacturing the compound of formula (18) may be found in the U.S. Pat. Nos. 4,851,530 and 4,913,544, the disclosures of which are incorporated herein by reference in their entirety. A number of photochromic dyes are commercially available from Keystone Aniline Company under the product names Reversocal Storm Purple, Plum Red, Berry Red, Corn Yellow, Oxford Blue and the like. Corn Yellow and Berry Red are chromene compounds, while Storm Purple and Plum Red are spirooxazics. The photo-induced rearrangement of chromenes occurs as follows:

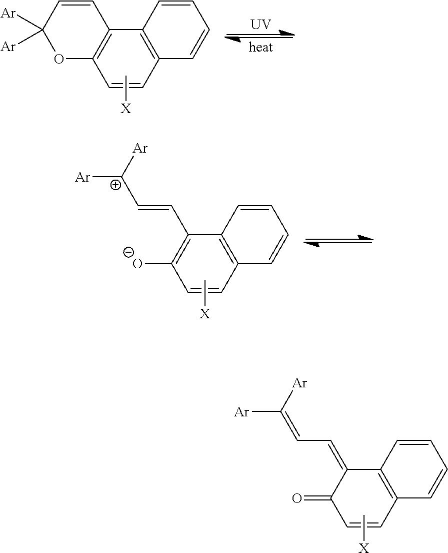

and the photo-induced rearrangement of spirooxazenes occurs as follows:

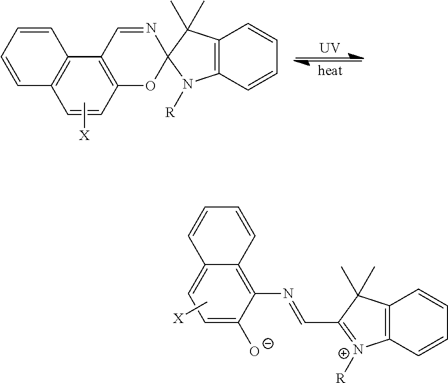

where Ar represents an aromatic group and X represents zero or more non-hydrogen substituents on the fused ring structure(s).

The supercritical CO₂ imbibition method described herein can be carried out by introducing the liquid CO₂ into a high-pressure test cell or other vessel containing the plastic article and additive (e.g., photochromic dye), and then raising the temperature and pressure above the critical point (7.38 megaPascals (MPa) and 31.1° C.) to form supercritical CO₂. The temperature and pressure is raised during processing to any combination of temperature and pressure above the critical point. The pressure cell can be equipped with a stirrer to assist in dissolving or dispersing the additive in the supercritical CO₂. As used herein, the phrase “dissolving or dispersing” includes forming a solution of the additive in fluid supercritical CO₂, dispersing particles (including microparticles and nanoparticles) of an insoluble additive in fluid supercritical CO₂, and also dissolving a portion of the additive in fluid supercritical CO₂ and dispersing particles of any undissolved additive in fluid supercritical CO₂. In some embodiments, the final temperature is from 50° C. to 140° C., more specifically from 60° C. to 120° C. In some embodiments, the final temperature is above the glass transition temperature of the thermoplastic composition. In some embodiments, the final temperature is above the glass transition temperature of the first polymer component. In some embodiments, the final pressure ranges from 50 MPa to 350 MPa, and more specifically from 120 MPa to 320 MPa. Concentrations of the additive in the CO₂ can vary depending on factors such as the characteristics of the thermoplastic composition, the characteristics of the additive, and the desired loading levels of the additive in the article. In some embodiments, the concentration can range from 10⁻⁴-10⁻⁷ mole additive/mole CO₂. The duration of the contact between the supercritical CO₂ and the plastic article can vary on these same types of factors, and can vary from 5 to 25 minutes, more specifically from 10 to 15 minutes.

The above-described batch technique for imbibing additives into thermoplastic articles is of course only a simplified technique to demonstrate the concept. Commercial applications could utilize semi-batch or continuous processes to move thermoplastic through process zone(s) to be brought into contact with additive-containing supercritical CO₂.

Thermoplastic compositions can be manufactured by various methods. For example, powdered polymer and other optional components are first blended in a mixer such as a HENSCHEL-Mixer™ high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

Transparent compositions can be produced by manipulation of the process used to manufacture the thermoplastic composition. One example of such a process to produce transparent poly(siloxane-carbonate) copolymer compositions is described in U.S. Patent Application No. 2003/0032725, the disclosure of which is incorporated herein by reference in its entirety.

Shaped, formed, or molded articles comprising the thermoplastic compositions are also provided. In addition to optical elements and lenses, the thermoplastic compositions can be molded into useful shaped articles by a variety of means such as injection molding, extrusion, rotational molding, blow molding and thermoforming to form articles such as, for example, computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like.

### NUMBERED EMBODIMENTS

Set forth below are some embodiments of the method of making a plastic article and the plastic article made therefrom as disclosed herein.

### Embodiment 1

A method of making a plastic article, comprising:

forming a plastic article from a thermoplastic composition comprising a first polymer component that comprises: (i) a poly(siloxane-carbonate) copolymer, (ii) a poly(aliphatic ester)-polycarbonate comprising soft block ester units, derived from monomers comprising an alpha, omega C₆₋₂₀ aliphatic dicarboxylic acid or derivative thereof, a dihydroxyaromatic compound, and a carbonate source, (iii) a blend of a polycarbonate and a polyester, (iv) a thermoplastic polyurethane, or mixtures comprising any of the foregoing; and contacting a surface of the article comprising the thermoplastic composition with a supercritical fluid carbon dioxide comprising an additive dissolved or dispersed therein.

### Embodiment 2

The method of embodiment 1, wherein the first polymer component comprises the poly(siloxane-carbonate) copolymer.

### Embodiment 3

The method of embodiment 2, wherein the poly(siloxane-carbonate) copolymer comprises from 1 to 50 wt. % siloxane units based on the total weight of the polymer.

### Embodiment 4

The method of embodiment 3, wherein the poly(siloxane-carbonate) copolymer comprises from 2 to 30 wt. % siloxane units.

### Embodiment 5

The method of embodiment 3, wherein the poly(siloxane-carbonate) copolymer comprises from 3 to 25 wt. % siloxane units.

### Embodiment 6

The method of any of embodiments 2-5, wherein the poly(siloxane-carbonate) copolymer comprises polysiloxane units represented by either or both of formulas (11) and (12)

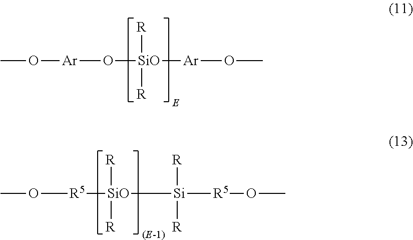

wherein each R independently represents a C₁₋₁₃ monovalent organic group; E has an average value of 2 to 1000; each Ar independently represents a group derived from a C₆-C₃₀ dihydroxyarylene compound; and each R⁵ independently represents a C₁-C₃₀ divalent organic group.

### Embodiment 7

The method of embodiment 1, wherein the first polymer component comprises the poly(aliphatic ester)-polycarbonate comprising soft block ester units, derived from the monomers comprising the alpha, omega C₆₋₂₀ aliphatic dicarboxylic acid or the derivative thereof, the dihydroxyaromatic compound, and the carbonate source.

### Embodiment 8

The method of embodiment 7, wherein the poly(aliphatic ester)-polycarbonate is of the formula (6b)

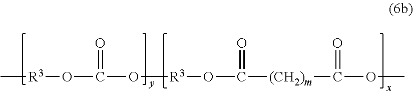

wherein m is 4 to 18, x and y each represent average weight percentages of the poly(aliphatic ester)-polycarbonate wherein the average weight percentage ratio x:y is 10:90 to 1:99, wherein x+y is 100, and each R³ is independently derived from a dihydroxyaromatic compound of formula (3)

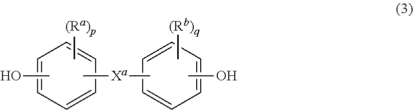

wherein R^{a} and R^{b} are each independently a halogen, C₁₋₁₂ alkoxy, or C₁₋₁₂ alkyl; X^{a} is a single bond, —O—, —S—, —S(O)—, S(O)₂—, —C(O)—, or a C₁₋₁₈ organic group; and p and q are each independently integers of 0 to 4 or formula (5)

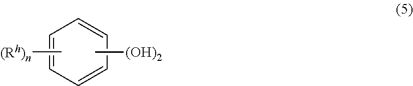

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4.

### Embodiment 9

The method of embodiment 7, wherein the poly(aliphatic ester)-polycarbonate is of formula (6c)

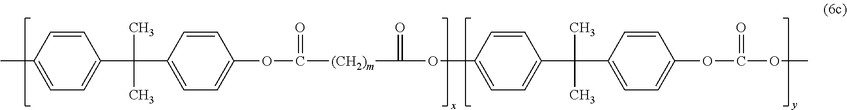

wherein m is 4 to 18 and wherein the average weight percentage ratio x:y is 10:90 to 1:99, wherein x+y is 100.

### Embodiment 10

The method of embodiments 8 or 9, wherein m is 8 to 10.

### Embodiment 11

The method of embodiment 1, wherein the first polymer component is the blend of a polycarbonate and a polyester.

### Embodiment 12

The method of embodiment 11, wherein the polyester is poly(1,4-cyclohexane dimethylene 1,4-cyclohexanedicarboxylate).

### Embodiment 13

The method of any of embodiments 1-12, wherein the poly(siloxane-carbonate) copolymer, the poly(aliphatic ester)-polycarbonate, or the polycarbonate of the blend of the polycarbonate and the polyester comprises carbonate units according to formula (1)

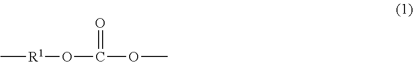

in which at least 60 percent of the total number of R¹ groups contain aromatic moieties and the balance thereof are aliphatic, alicyclic, or aromatic.

### Embodiment 14

The method of embodiment 1, wherein the first polymer component is a thermoplastic polyurethane.

### Embodiment 15

The method of any of any of embodiments 1-14, wherein the first polymer component comprises a blend of two or more of: (i) a poly(siloxane-carbonate) copolymer, (ii) a poly(aliphatic ester)-polycarbonate comprising soft block ester units, derived from monomers comprising an alpha, omega C₆₋₂₀ aliphatic dicarboxylic acid or derivative thereof, a dihydroxyaromatic compound, and a carbonate source, (iii) a blend of a polycarbonate and a polyester, and (iv) a thermoplastic polyurethane

### Embodiment 16

The method of any of embodiments 1-15, wherein the thermoplastic composition further comprises a second polymer that is a polycarbonate different from the first polymer component.

### Embodiment 17

The method of embodiment 16, wherein the first polymer component is a poly(siloxane-carbonate) copolymer and the second polymer is free of polysiloxane units.

### Embodiment 18

The method of embodiments 16 or 17, wherein the second polymer component comprises carbonate units according to formula (1)

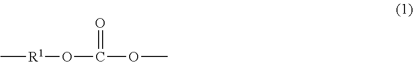

in which at least 60 percent of the total number of R¹ groups contain aromatic moieties and the balance thereof are aliphatic, alicyclic, or aromatic, with the proviso that R¹ is other than polysiloxane.

### Embodiment 19

The method of any of embodiments 1-18, wherein the surface of the article is contacted with supercritical CO₂ at a temperature of at least 40° C.

### Embodiment 20

The method of embodiment 19, wherein the surface of the article is contacted with supercritical CO₂ at a temperature of 40-120° C.

### Embodiment 21

The method of embodiment 19, wherein the surface of the article is contacted with supercritical CO₂ at a temperature of 60-80° C.

### Embodiment 22

The method of any of embodiments 1-21, wherein the surface of the article is contacted with supercritical CO₂ at a pressure of at least 10 MPa.

### Embodiment 23

The method of embodiment 22, wherein the surface of the article is contacted with supercritical CO₂ at a pressure of 12-40 MPa.

### Embodiment 24

The method of embodiment 22, wherein the surface of the article is contacted with supercritical CO₂ at a pressure of 12-32 MPa.

### Embodiment 25

The method of any of embodiments 1-24, wherein the surface of the article is contacted supercritical CO₂ for at least 5 minutes.

### Embodiment 26

The method of embodiment 25, wherein the surface of the article is contacted supercritical CO₂ for 5-20 minutes.

### Embodiment 27

The method of embodiment 25, wherein the surface of the article is contacted supercritical CO₂ for 10-15 minutes.

### Examples

The thermoplastic composition is further illustrated by the following non-limiting examples, which use the following components.

TABLE 1

| | | |
|---|---|---|
| PC-1 | BPA polycarbonate made by an interfacial | SABIC |
| | process with an MVR at 300° C./1.2 kg, of | Innovative |
| | 19-23 g/cm³ | Plastics |
| PC-Si-1 | BPA polycarbonate polysiloxane copolymer made | SABIC |
| | by an interfacial process with an MVR at 300° C./ | Innovative |
| | 1.2 kg, of 17-21 g/cm³ | Plastics |
| PC-Si-2 | BPA polycarbonate polysiloxane copolymer made | SABIC |
| | by an interfacial process with an MVR at 300° C./ | Innovative |
| | 1.2 kg, of 7-11 g/cm³ | Plastics |
| TPU | ELASTOLLAN C78A | BASF |
| PC-PE-1 | poly(aliphatic ester)-polycarbonate copolymers | SABIC |
| | with a MVR at 300° C./1.2 kg of 38-42 g/cm³ | Innovative |
| | | Plastics |
| PC-PE-2 | BPA polycarbonate and PCCD cycloaliphatic | SABIC |
| | polyester with a MVR at 265° C./2.16 kg of | Innovative |
| | 8-14 g/cm³ | Plastics |
| PC-2 | High heat polycarbonate copolymer made by an | SABIC |
| | interfacial process with an MVR of 330° C./ | Innovative |
| | 2.16 kg of 20-26 g/cm³ | Plastics |
| PC-3 | High heat polycarbonate copolymer made by an | SABIC |
| | interfacial process with an MVR of 330° C./ | Innovative |
| | 1.2 kg of 7-11 g/cm³ | Plastics |

Test samples (size 20*30*2.5 mm) of the polymer resins set forth in Table 1 were prepared and placed in a high pressure test cell. In a storage vessel, about 500 mg milligrams of Berry Red is dispersed in about 60 ml of liquefied carbon dioxide at 80° C. and 24 MPa. The cell, loaded with the test samples and the mixture of liquefied carbon dioxide and Berry Red, is heated and the pressure raised to the conditions set forth and for the amount of time specified in Table 2. These conditions are maintained for the specified time, after which the pressure is slowly reduced and the carbon dioxide is released to the storage vessel, after which the test samples are removed and evaluated. For some samples, the Berry Red was first dispersed in ethanol before introducing into the storage vessel. After removal from the test cell, the samples are exposed to UV radiation to activate the photochromic dye, and the depth of penetration of the dye into the plastic is measured by microscopic optical examination depth of the dye response across a cross-section on opposite ends of the test sample (left and right). The results are set forth in Table 2.

TABLE 2

| | | | | | Penetration | Penetration |
|---|---|---|---|---|---|---|
| | | Pressure | Temperature | Time | on left | on right |
| Resin | Additive | (MPa) | (° C.) | (min.) | (μm) | (μm) |
| PC-1 | Berry Red | 24.0 | 80 | 10 | 17 | 20 |
| PC-1 | Berry Red | 32.0 | 80 | 10 | 31 | 33 |
| PC-1 | Berry Red | 12.0 | 60 | 10 | 34 | 33 |
| | in ethanol | | | | | |
| PC-Si-1 | Berry Red | 24.0 | 80 | 10 | 24 | 24 |
| PC-Si-1 | Berry Red | 12.0 | 80 | 10 | 52 | 54 |
| | in ethanol | | | | | |
| TPU | Berry Red | 24.0 | 80 | 10 | >150 | >150 |
| PC-PE-1 | Berry Red | 24 | 80 | 10 | 41 | 43 |
| | in ethanol | | | | | |

The data in Table 2 demonstrate that the poly(siloxane-carbonate) copolymer provided significantly higher depths of penetration versus the comparison material, providing its best average penetration of 53 μm versus to 33.5 μm for the comparison, dispersing the dye in ethanol and exposing to supercritical CO₂ at 12.0 MPa and 60° C. A significant advantage was also observed without dispersing in alcohol and with supercritical CO₂ at 24.0 MPa and 80° C., with the poly(siloxane-carbonate) copolymer providing average penetration of 32 μm versus 24 μm for the comparison.

Test samples (size 20*30*2.5 mm) of the polymer resins set forth in Table 1 were prepared and placed in a high pressure test cell. In a storage vessel, about 500 mg milligrams of Sea Green is dispersed in about 60 ml of liquefied carbon dioxide at 80° C. and 24 MPa. The cell, loaded with the test samples and the mixture of liquefied carbon dioxide and Sea Green, is heated and the pressure raised to the conditions set forth and for the amount of time specified in Table 3. These conditions are maintained for the specified time, after which the pressure is slowly reduced and the carbon dioxide is released to the storage vessel, after which the test samples are removed and evaluated. After removal from the test cell, the color properties of the samples are measured according to ASTM D1033-87 before and after exposure to UV radiation to activate the photochromic dye, and the depth of penetration of the dye into the plastic is measured by microscopic optical examination depth of the dye response across a cross-section on opposite ends of the test sample (left and right). The results are set forth in Table 3.

TABLE 3

| Sample | | Pressure | Temp. | Time | Non exposed samples | | | Exposed to UV light | | | Color Shift | | | |
|---|---|---|---|---|---|---|---|---|---|---|---|---|---|---|
| No. | Resin | (Bar) | (° C.) | (min) | L | A | B | L | A | B | dL | dA | dB | DE |
| 8 | PC-PE-2 | 250 | 80 | 2 | 34.26 | −2.10 | −1.39 | 31.92 | −4.61 | −3.08 | −2.34 | −2.51 | −1.69 | 3.83 |
| 9 | PC-PE-2 | 250 | 80 | 30 | 40.28 | −6.03 | −5.31 | 34.18 | −9.09 | −7.86 | −6.10 | −3.06 | −2.55 | 7.29 |
| 10 | PC-PE-2 | 250 | 80 | 4 | 34.85 | −2.31 | −1.75 | 32.32 | −4.96 | −3.93 | −2.53 | −2.66 | −2.17 | 4.26 |
| 11 | PC-PE-2 | 250 | 80 | 8 | 35.50 | −2.89 | −2.53 | 33.68 | −4.52 | −4.13 | −1.82 | −1.63 | −1.59 | 2.92 |
| 12 | PC-PE-2 | 250 | 80 | 16 | 35.66 | −4.52 | −4.31 | 32.75 | −6.94 | −5.51 | −2.92 | −2.42 | −1.20 | 3.97 |
| 13 | PC-PE-2 | 250 | 60 | 5 | 34.42 | −1.34 | −1.23 | 33.61 | −2.27 | −1.98 | −0.81 | −0.92 | −0.75 | 1.44 |
| 14 | PC-PE-2 | 250 | 60 | 2 | 34.84 | −0.92 | −0.59 | 33.81 | −2.17 | −1.46 | −1.03 | −1.25 | 00.87 | 1.84 |
| 15 | PC-PE-2 | 250 | 60 | 60 | 35.91 | −1.88 | −3.82 | 33.80 | −4.06 | −5.40 | −2.11 | −2.18 | −1.58 | 3.42 |
| 16 | PC-2 | 250 | 80 | 10 | 36.26 | −0.29 | −0.85 | 36.19 | 0.35 | 0.74 | −0.07 | −0.06 | 0.11 | 0.14 |
| 17 | PC-1 | 150 | 60 | 5 | 35.89 | −0.85 | −0.59 | 35.71 | −1.06 | −0.67 | −0.18 | −0.20 | −0.08 | 0.28 |
| 18 | PC-Si-2 | 150 | 60 | 5 | 36.48 | −0.18 | −3.37 | 36.28 | −0.52 | −3.62 | 0.19 | −0.34 | −0.24 | 0.46 |
| 19 | PC-3 | 150 | 60 | 5 | 36.12 | −0.20 | −0.86 | 36.13 | −0.21 | −0.88 | 0.01 | −0.01 | −0.02 | 0.03 |
| 20 | PC-PE-1 | 250 | 80 | 2 | 34.46 | −2.55 | −0.64 | 33.23 | −3.99 | −1.82 | −1.23 | −1.44 | −1.19 | 2.24 |
| 21 | PC-PE-1 | 250 | 80 | 30 | 56.82 | −11.98 | −1.29 | 48.74 | −16.50 | −6.35 | −8.08 | −4.52 | −5.06 | 10.55 |
| 22 | PC-PE-1 | 250 | 80 | 4 | 35.09 | −2.64 | −0.62 | 32.56 | −4.95 | −2.57 | −2.53 | −2.31 | −1.94 | 3.94 |
| 23 | PC-PE-1 | 250 | 80 | 8 | 35.08 | −4.00 | −0.83 | 30.72 | −5.38 | −2.46 | −4.36 | −1.37 | −1.62 | 4.85 |
| 24 | PC-PE-1 | 250 | 80 | 16 | 42.77 | −9.11 | −2.90 | 38.16 | −12.01 | −5.77 | −4.61 | −2.91 | −2.86 | 6.16 |
| 25 | PC-PE-1 | 250 | 60 | 5 | 35.16 | −0.81 | −0.83 | 34.57 | −1.64 | −1.49 | −0.59 | −0.83 | −0.66 | 1.21 |
| 26 | PC-PE-1 | 250 | 60 | 2 | 35.69 | 0.65 | −1.74 | 34.71 | −1.46 | −2.04 | −0.99 | −0.80 | −0.31 | 1.31 |
| 27 | PC-PE-1 | 250 | 60 | 60 | 35.63 | −1.60 | −0.68 | 34.10 | −3.47 | −2.10 | −1.54 | −1.87 | −1.42 | 2.81 |

The data in Table 3 demonstrate that the poly(aliphatic ester)-polycarbonate copolymers containing soft block ester units exhibited significantly higher dE than the other samples, indicative of greater change and greater photochromic effect.

The singular forms “a,” “an,” and “the” include plural referents unless the context clearly dictates otherwise. The modifier “about” used in connection with a quantity is inclusive of the stated value and has the meaning dictated by the context (e.g., includes the degree of error associated with measurement of the particular quantity). The terms “front”, “back”, “bottom”, and/or “top” are used herein, unless otherwise noted, merely for convenience of description, and are not limited to any one position or spatial orientation. The word “or” means “and/or”. The endpoints of all ranges directed to the same component or property are inclusive and independently combinable (e.g., ranges of “less than or equal to about 25 wt %, or, more specifically, about 5 wt % to about 20 wt %,” is inclusive of the endpoints and all intermediate values of the ranges of “about 5 wt % to about 25 wt %,” etc.). The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or can not occur, and that the description includes instances where the event occurs and where it does not.

As used herein, the term “hydrocarbyl” refers broadly to a substituent comprising carbon and hydrogen, optionally with 1 to 3 heteroatoms, for example, oxygen, nitrogen, halogen, silicon, or sulfur; “alkyl” refers to a straight or branched chain monovalent hydrocarbon group; “alkylene” refers to a straight or branched chain divalent hydrocarbon group; “alkylidene” refers to a straight or branched chain divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicylic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A method of making a plastic article, comprising:
forming a plastic article from a thermoplastic composition comprising a first polymer component that comprises: (i) a poly(siloxane-carbonate) copolymer, (ii) a poly(aliphatic ester)-polycarbonate comprising soft block ester units, derived from monomers comprising an alpha, omega C₆₋₂₀ aliphatic dicarboxylic acid or derivative thereof, a dihydroxyaromatic compound, and a carbonate source, (iii) a blend of a polycarbonate and a polyester, (iv) a thermoplastic polyurethane, or a combination comprising any of the foregoing; and
contacting a surface of the article comprising the thermoplastic composition with supercritical fluid carbon dioxide comprising an additive dissolved or dispersed therein.

2. The method of claim 1, wherein the first polymer component component comprises the poly(siloxane-carbonate) copolymer.

3. The method of claim 2, wherein the poly(siloxane-carbonate) copolymer comprises from 1 to 50 wt. % siloxane units based on the total weight of the poly(siloxane-carbonate) copolymer.

4. The method of claim 3, wherein the poly(siloxane-carbonate) copolymer comprises from 2 to 30 wt. % siloxane units.

5. The method of claim 3, wherein the poly(siloxane-carbonate) copolymer comprises from 3 to 25 wt. % siloxane units.

6. The method of claim 2, wherein the poly(siloxane-carbonate) copolymer comprises polysiloxane units represented by either or both of formulas (11) and (12) 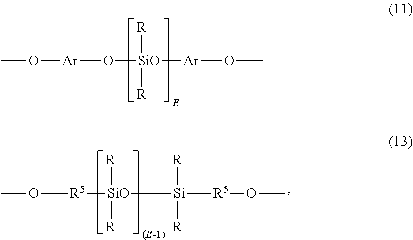
wherein
each R independently represents a C₁₋₁₃ monovalent organic group;
E has an average value of 2 to 1000;
each Ar independently represents a group derived from a C₆-C₃₀ dihydroxyarylene compound; and
each R⁵ independently represents a C₁-C₃₀ divalent organic group.

7. The method of claim 1, wherein the first polymer component comprises the poly(aliphatic ester)-polycarbonate comprising the soft block ester units, derived from the monomers comprising the alpha, omega C₆₋₂₀ aliphatic dicarboxylic acid or the derivative thereof, the dihydroxyaromatic compound, and the carbonate source.

8. The method of claim 7, wherein the poly(aliphatic ester)-polycarbonate is of the formula (6b) 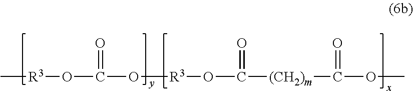
wherein m is 4 to 18, x and y each represent average weight percentages of the poly(aliphatic ester)-polycarbonate wherein the average weight percentage ratio x:y is 10:90 to 1:99, wherein x+y is 100, and each R³ is independently derived from a dihydroxyaromatic compound of formula (3) 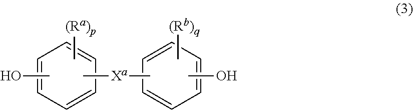
wherein R^{a} and R^{h} are each independently a halogen, C₁₋₁₂ alkoxy, or C₁₋₁₂ alkyl; X^{a} is a single bond, —O—, —S—, —S(O)—, S(O)₂—, —C(O)—, or a C₁₋₁₈ organic group; and p and q are each independently integers of 0 to 4 or formula (5) 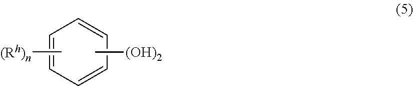
wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4.

9. The method of claim 7, wherein the poly(aliphatic ester)-polycarbonate is of formula (6c) 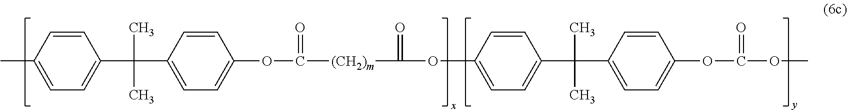
wherein m is 4 to 18 and wherein the average weight percentage ratio x:y is 10:90 to 1:99, wherein x+y is 100.

10. The method of claim 8, wherein m is 8 to 10.

11. The method of claim 1, wherein the first polymer component comprises the blend of the polycarbonate and the polyester.

12. The method of claim 11, wherein the polyester is poly(1,4-cyclohexane dimethylene 1,4-cyclohexanedicarboxylate)

13. The method of claim 1, wherein the poly(siloxane-carbonate) copolymer, the poly(aliphatic ester)-polycarbonate, or the polycarbonate of the blend of the polycarbonate and the polyester comprises carbonate units according to formula (1) 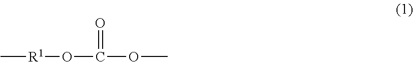
in which at least 60 percent of the total number of R¹ groups contain aromatic moieties and the balance thereof are aliphatic, alicyclic, or aromatic.

14. The method of claim 1, wherein the first polymer component comprises the thermoplastic polyurethane.

15. The method of claim 1, wherein the surface of the article is contacted with the supercritical CO₂ at a temperature of at least 40° C.

16. The method of claim 1, wherein the surface of the article is contacted with the supercritical CO₂ at a pressure of at least 10 MPa.

17. The method of claim 16, wherein the surface of the article is contacted with the supercritical CO₂ at a pressure of 12-40 MPa.

18. The method of claim 1, wherein the surface of the article is contacted with the supercritical CO₂ for at least 5 minutes.

19. The method of claim 1, wherein the additive is a photochromic dye.

20. A plastic article made according to the method of claim 1.
